(19) United States
(12) Patent Application Publication
(10) Pub. No.: US 2025/0367934 A1
(43) Pub. Date: Dec. 4, 2025

(54) PRINTING APPARATUS

(71) Applicant: CANON KABUSHIKI KAISHA, Tokyo (JP)

(72) Inventors: NOBUHIRO TOKI, Kanagawa (JP); ERIKA IYAMA, Kanagawa (JP); YUSUKE TANAKA, Kanagawa (JP); HIROMASA TSUTSUMI, Kanagawa (JP); YUSUKE NARATANI, Tokyo (JP); KOKI SHIMADA, Kanagawa (JP); FUMIE KAMEYAMA, Tokyo (JP); MOTONORI HITOMI, Kanagawa (JP); TAIJI MARUYAMA, Kanagawa (JP); HIDEAKI MATSUMURA, Tokyo (JP)

(21) Appl. No.: 19/220,388

(22) Filed: May 28, 2025

(30) Foreign Application Priority Data
May 30, 2024 (JP) 2024-088275

(51) Int. Cl. B41J 2/17; B41J 29/00

(52) U.S. Cl. CPC B41J 2/1721; B41J 29/00

(57) ABSTRACT

A printing apparatus including a printhead for printing by discharging ink, comprising an output unit for outputting waste ink discharged from the printhead, and a container which can inserted in or removed from an apparatus main body, the container being connected to the output unit and receiving the waste ink output from the output unit in a state where the container is inserted into the apparatus main body, the output unit including a channel portion for deriving the waste ink, the channel portion engaging with the container to position the container inserted into the apparatus main body, and the channel portion being configured to not to come into surface contact with the container at the time of insertion or removal of the container.

### CROSS-REFERENCE TO PRIORITY APPLICATION

This application claims the benefit of Japanese Patent Application No. 2024-088275, filed May 30, 2024, which is hereby incorporated by reference herein in its entirety.

### BACKGROUND

### Field of the Technology

The present disclosure mainly relates to a printing apparatus.

### Description of the Related Art

Japanese Patent Laid-Open No. 2012-196803 discloses, as an example of a printing apparatus, an inkjet printer including an exchangeable waste liquid container (waste liquid storage container). According to patent literature 1, the waste liquid container is fixed by a waste liquid introduction unit configured to introduce a waste liquid such as waste ink into the waste liquid container.

If a waste liquid more than a standard is stored in the waste liquid container, the waste liquid container is exchanged by a user. Hence, there is a demand for a technique that enables a relatively easy waste liquid container exchange work and is advantageous in improving usability.

### SUMMARY

The present disclosure provides a technique advantageous for improving usability of a printing apparatus.

One of the aspects of the present disclosure provides a printing apparatus including a printhead configured to perform printing by discharging ink, comprising: an output unit configured to output waste ink discharged from the printhead; and a container configured to be inserted/removed into/from an apparatus main body, the container being connected to the output unit and receiving the waste ink output from the output unit in a state in which the container is inserted into the apparatus main body, wherein the output unit includes a channel portion configured to derive the waste ink, the channel portion engages with the container to position the container inserted into the apparatus main body, and the channel portion is configured to not to come into surface contact with the container at the time of insertion/removal of the container.

Features of the present disclosure will become apparent from the following description of embodiments with reference to the attached drawings. The following description of embodiments are described by way of example.

### BRIEF DESCRIPTION OF THE DRAWINGS

FIG. 1 is a perspective view showing the internal structure of a printing apparatus according to an embodiment;

FIG. 2 is a partially enlarged view of the printing apparatus;

FIG. 3 is a perspective view of a waste ink container storage unit;

FIG. 4 is a perspective view of a waste ink container;

FIG. 5 is a plan view of a waste ink container stored in the waste ink container storage unit;

FIG. 6 is a schematic sectional view of the waste ink container storage unit and the waste ink container;

FIG. 7A is a schematic sectional view of the waste ink container storage unit and the waste ink container;

FIG. 7B is a schematic sectional view of the waste ink container storage unit and the waste ink container;

FIG. 8 is a perspective view of the waste ink container from which a container lid portion is detached;

FIG. 9 is a perspective view of a waste ink container according to another embodiment;

FIG. 10 is a perspective view of the waste ink container according to the other embodiment;

FIG. 11 is a perspective view of the waste ink container according to the other embodiment; and

FIG. 12 is a perspective view of the waste ink container according to the other embodiment.

### DESCRIPTION OF THE EMBODIMENTS

Hereafter, embodiments will be described in detail with reference to the attached drawings. Note, the following embodiments are not intended to limit the scope of the claims. Multiple features are described in the embodiments, but it is not the case that all such features are required, and multiple such features may be combined as appropriate. Furthermore, in the attached drawings, the same reference numerals are given to the same or similar configurations, and redundant description thereof is omitted.

### First Embodiment

### (Apparatus Configuration)

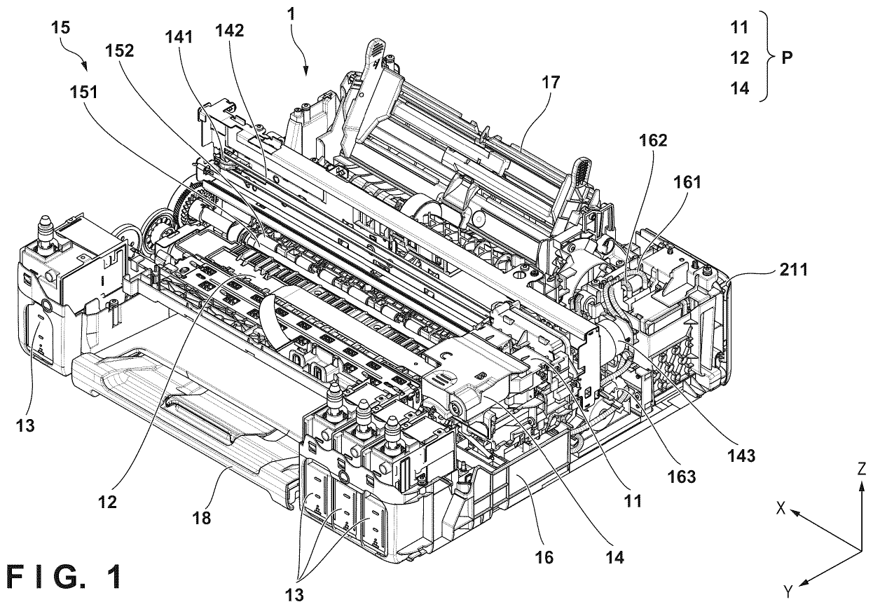

An example of the configuration of a printing apparatus 1 according to the first embodiment will be described with reference to FIG. 1. To facilitate understanding of a structure, the X direction, the Y direction, and the Z direction, which cross each other (or are substantially orthogonal to each other) are shown in FIG. 1 (the same applies to other drawings to be described later). The X direction corresponds to the left/right direction/widthwise direction, the Y direction corresponds to the front/rear direction/depth direction, and the Z direction corresponds to the up/down direction/height direction.

The printing apparatus 1 is an inkjet printer including a printhead 11 that performs printing by discharging ink to a print medium. Printing here indicates forming an image on a print medium, and the concept of an image includes a character, a number, a symbol, a graphic, and a photograph, and can also include a space formed therebetween. A typical example of the print medium is a sheet-shaped paper material.

Although a detailed description will be omitted here, a plurality of nozzles are arrayed in the printhead 11. When a plurality of heaters (electrothermal transducers) corresponding to the plurality of nozzles are energized, heated and foamed ink is discharged from corresponding nozzles. As another embodiment, in the printhead 11, a piezoelectric element may be used in place of the heater.

In this embodiment, the printing apparatus 1 further includes a platen 12, an ink tank 13, a carriage 14, a conveyance unit 15, a recovery unit 16, a feeding unit 17, and a discharge unit 18.

The platen 12 is provided facing the printhead 11, and supports a print medium as a print target from the side opposite to the printhead 11.

The ink tank 13 stores ink to be supplied to the printhead 11. The ink in the ink tank 13 is supplied to the printhead 11 via a tube (not shown), and the printhead 11 discharges the supplied ink when performing printing. In this embodiment, inks of a plurality of types (and additionally a plurality of colors) are used, and a plurality of ink tanks 13 are attached to the apparatus main body. The apparatus main body here can be interpreted in a broad sense, and includes frame members that form a frame for the internal structure of the printing apparatus 1, exterior panels incorporating these, or a housing.

Examples of the plurality of types of inks are pigment inks and dye inks. Also, in the above-described configuration, ink is supplied from the ink tank 13 to the printhead 11 via a tube. However, the ink tank 13 may be formed as an ink cartridge type that is integrated with the printhead 11.

The carriage 14 includes the printhead 11 mounted thereon and is configured to be movable reciprocally in the X direction, thereby scanning the printhead 11 in the X direction. In this embodiment, the carriage 14 includes a pulley 141, a belt 142, and a power source 143. When the belt 142 laid on the pulley 141 receives power from the power source 143 and travels, the carriage 14 slides along a rail extending in the X direction. As the power source 143, a known electric motor is used.

With this configuration, the printhead 11 can scan in the X direction and performs printing on a print medium during the scanning. The printhead 11 is also expressed as a serial head, and the printhead 11, the platen 12, and the carriage 14 are expressed as a printing unit P altogether. As another embodiment, the printhead 11 may be a line head extending in the whole region in the widthwise direction of the print medium.

The conveyance unit 15 conveys a print medium taken from the feeding unit 17 to the printing unit P and conveys the print medium printed by the printing unit P to the discharge unit 18. In this embodiment, the conveyance unit 15 includes a plurality of rollers arranged in the apparatus main body, and as an example of a part thereof, FIG. 1 shows a roller pair including a conveyance roller 151 and a pinch roller 152 arranged on the upstream side in the conveyance direction of the print medium.

The conveyance roller 151 is driven based on the power of a power source (not shown). The pinch roller 152 is biased against the conveyance roller 151 and is in rotatable contact with it. The conveyance roller 151 and the pinch roller 152 function as a nip portion that nips (clamps) a print medium, and convey the print medium taken from the feeding unit 17 to the printing unit P.

In the printing apparatus 1 including the printhead 11 as a serial head, an operation of the conveyance unit 15 conveying the print medium by a predetermined amount and an operation of the printhead 11 scanning and printing while the conveyance unit 15 suppresses the conveyance are alternately performed. Thus, the intermittent conveyance operation by the conveyance unit 15 and the scan printing operation by the printhead 11 are alternately performed, thereby implementing printing on the whole region of the print medium.

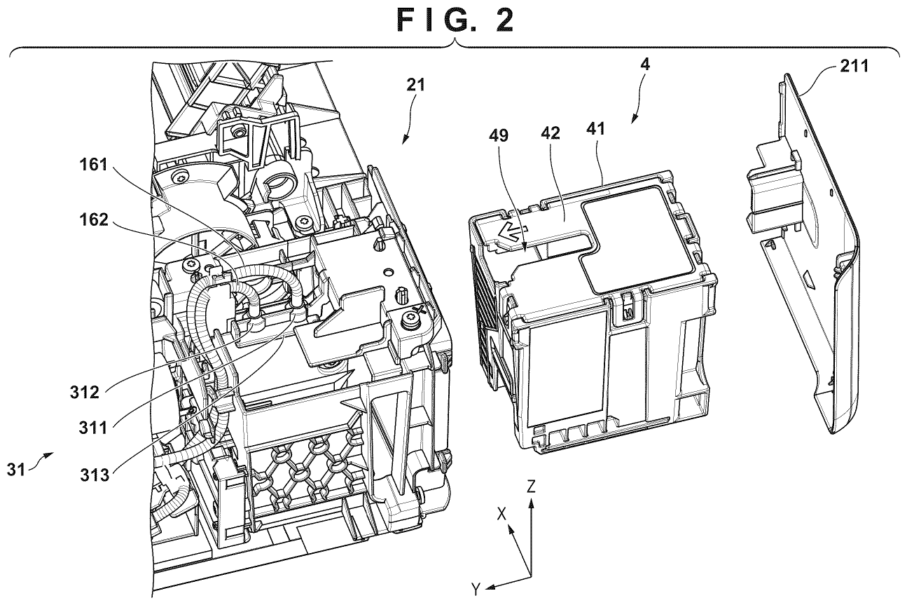

The recovery unit 16 is provided in a part of a region where the printhead 11 can be moved by the carriage 14 (typically, the region at one end portion of the region where the printhead 11 can be moved), and configured to recover the ink discharge function of the printhead 11. For example, the recovery unit 16 includes a suction pump 163 and performs a suction operation for the nozzle surface (ink discharge surface) of the printhead 11. Thus, bubbles or viscous ink in the nozzles is removed, and the ink discharge function of the printhead 11 is recovered. The sucked ink is sent as waste ink to a waste ink container 4 (see FIG. 2 and the like) to be described later.

The suction operation is performed for each ink type. In this embodiment, pigment ink and dye ink sucked by the suction pump 163 are individually sent to the waste ink container 4 via a waste ink tube 161 and a waste ink tube 162, respectively. For the sake of discrimination, the waste ink tube 161 and the waste ink tube 162 may be expressed as, for example, a waste pigment ink tube and a waste dye ink tube, respectively.

(Configurations of Waste Ink Container and Waste Ink Container Storage Unit) As shown in FIG. 2, the waste ink container 4 can be inserted/removed into/from the apparatus main body in the Y direction. In this embodiment, the printing apparatus 1 further includes a waste ink container storage unit 21 capable of implementing insertion/removal of the waste ink container 4. In this embodiment, the waste ink container storage unit 21 exchangeably stores the waste ink container 4 on the rear side of the apparatus.

As an example, if the waste ink amount output and stored in the waste ink container 4 reaches a standard, the printing apparatus 1 outputs a predetermined notification. In accordance with the notification, the user can detach a cover member 211 and remove the waste ink container 4 from the waste ink container storage unit 21. After that, the user inserts a new/another waste ink container 4 into the waste ink container storage unit 21, and attaches the cover member 211 to close the waste ink container storage unit 21.

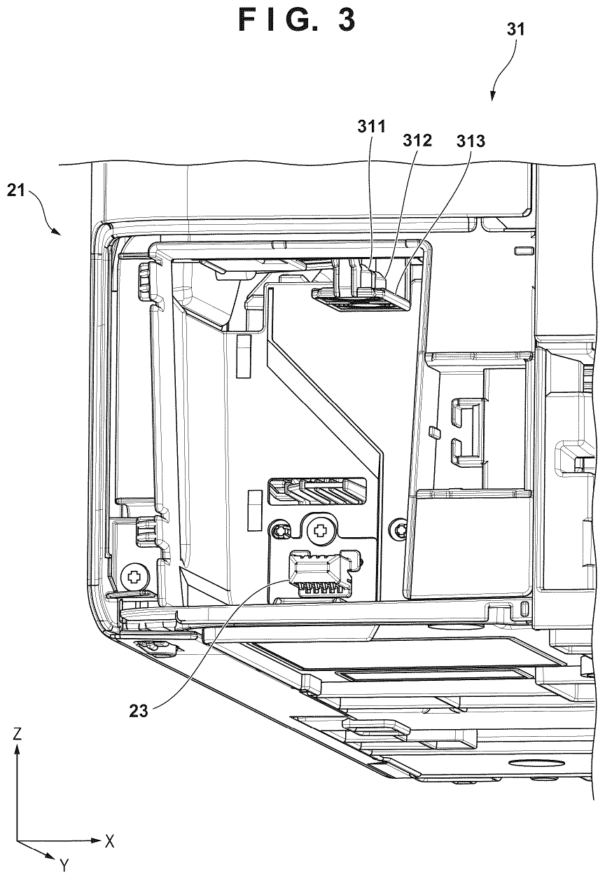

FIG. 3 is a perspective view showing the structure of the waste ink container storage unit 21 in a state in which the waste ink container 4 is not inserted. On the upper portion of the waste ink container storage unit 21, a waste ink output unit 31 capable of outputting waste ink sent via the waste ink tubes 161 and 162 to the waste ink container 4 is installed. As will be described later in detail, the waste ink output unit 31 includes tubular portions 311 and 312 connected to the waste ink tubes 161 and 162, respectively, and a plate-shaped portion 313 extending around the lower portions thereof, and they are integrally fixed to the apparatus main body.

In addition, an electrical connecting portion 23 that can electrically be connected to the waste ink container 4 is installed on the lower portion of the waste ink container storage unit 21. If the waste ink container 4 is inserted into the apparatus main body, the printing apparatus 1 and the waste ink container 4 exchange signals and, for example, measurement of the waste ink amount output and stored in the waste ink container 4 and recording of the result of the measurement are performed. With this configuration, the printing apparatus 1 can output a predetermined notification if the waste ink amount in the waste ink container 4 reaches a standard, and the user can exchange the waste ink container 4 in accordance with the notification.

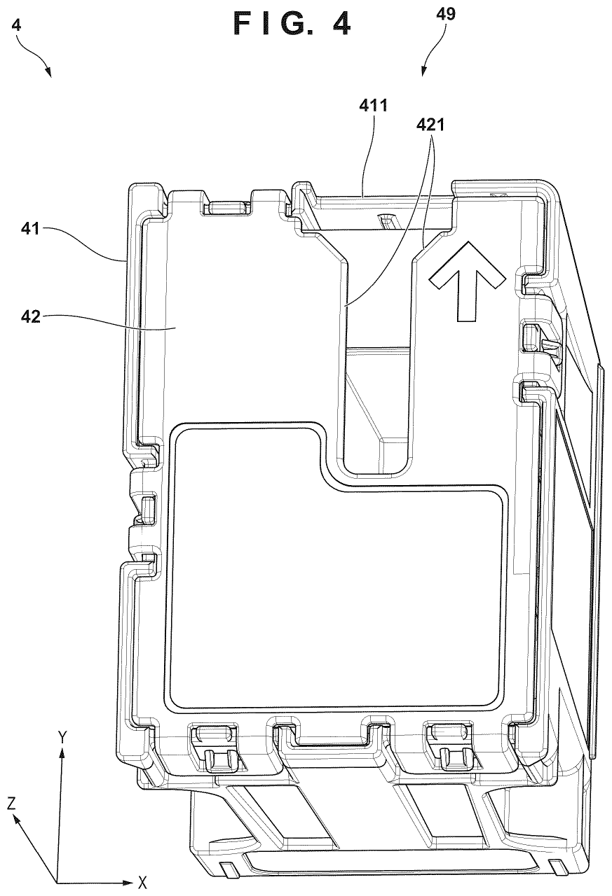

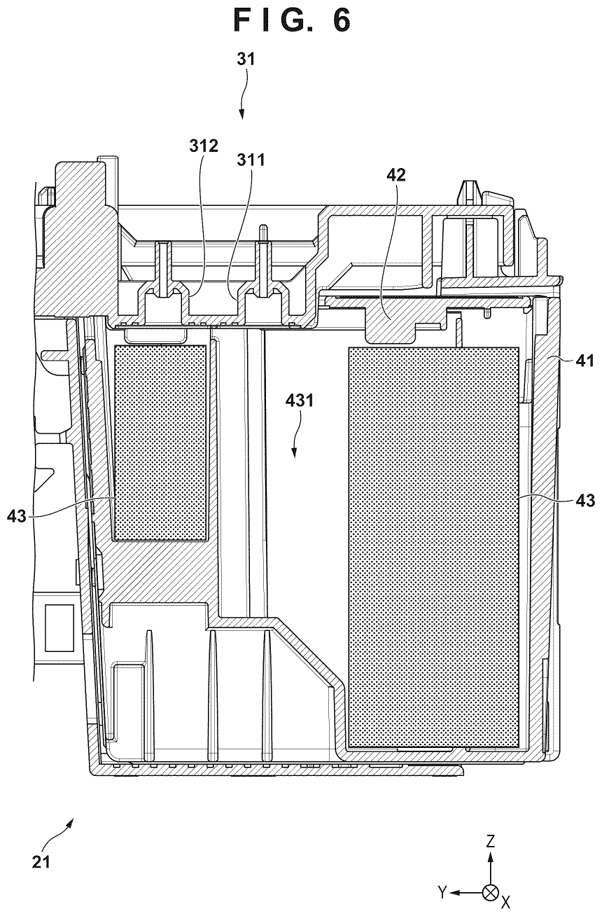

FIG. 4 is a perspective view of the waste ink container 4 viewed from above. The waste ink container 4 includes a container main body 41 and a container lid portion 42. As will be described later in detail, the container main body 41 is configured to store pigment ink and dye ink sent as waste ink and incorporates an absorber 43 (see FIG. 6) capable of absorbing the waste ink. The container lid portion 42 is attached and locked on the container main body 41 to seal the container main body 41 on the upper side.

A notch 49 extending in the insertion/removal direction (Y direction) of the waste ink container 4 is provided on the upper surface portion of the waste ink container 4. In this embodiment, the notch 49 is formed by a notch 411 of the container main body 41 and a notch 421 of the container lid portion 42, extends with a relatively narrow width/substantially linearly, and has a partially wide/open shape on the end portion side in the insertion direction. Thus, the waste ink container 4 can be inserted without interfering with the plate-shaped portion 313 of the waste ink output unit 31 and, after the insertion, engaged with the plate-shaped portion 313 at the relatively narrow/substantially linear portion of the notch 49.

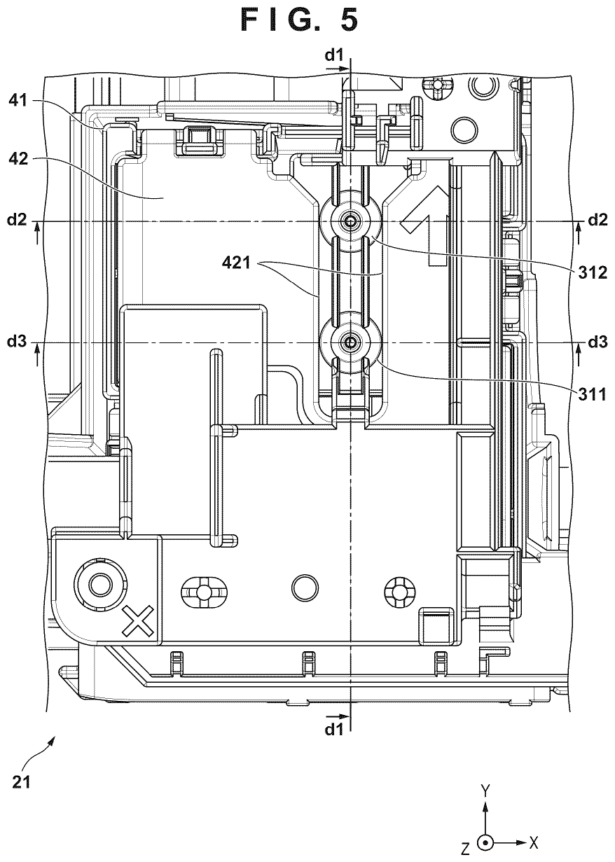

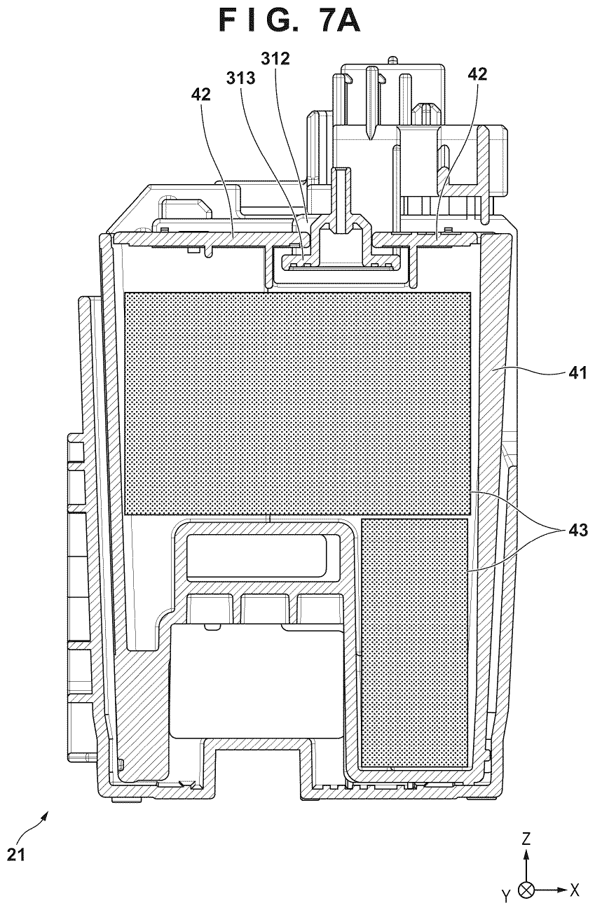

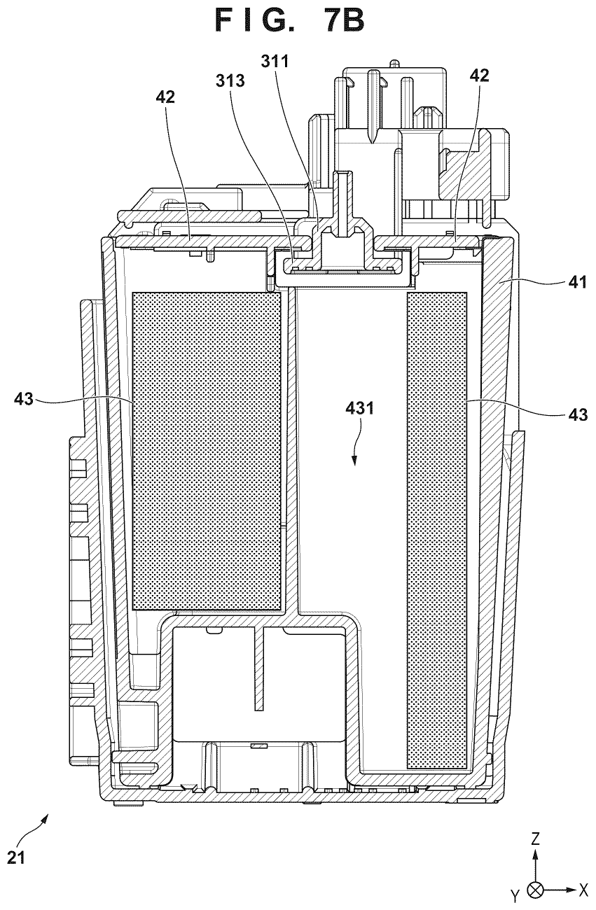

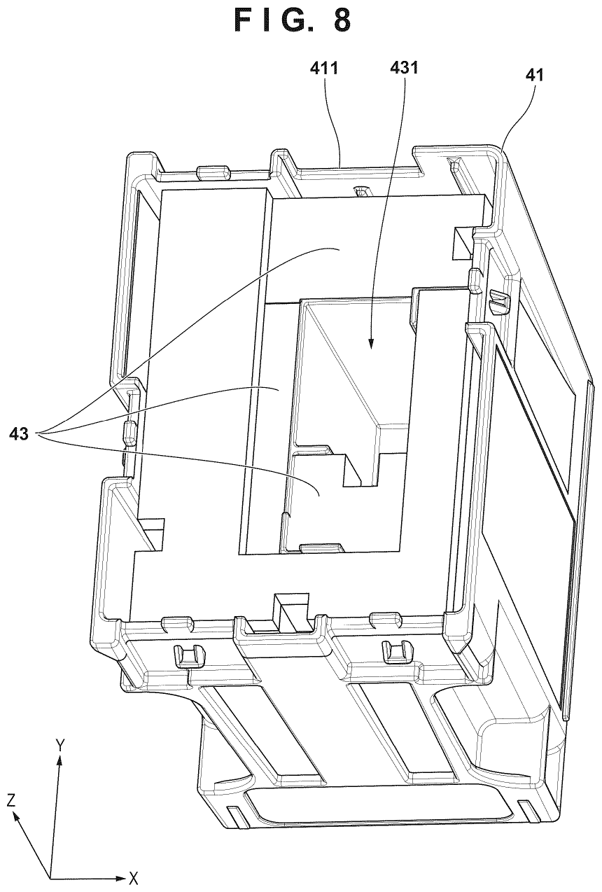

FIG. 5 is a plan view of the waste ink container 4 stored in the waste ink container storage unit 21. FIG. 6 is a Y-direction sectional view taken along a cut line d1-d1 in FIG. 5. FIG. 7A is an X-direction sectional view taken along a cut line d2-d2 in FIG. 5. FIG. 7B is an X-direction sectional view taken along a cut line d3-d3 in FIG. 5. Also, FIG. 8 is a perspective view of the waste ink container 4 whose container lid portion 42 is detached.

The first tubular portion 311 is connected to the waste ink tube 161 and derives pigment ink via the waste ink tube 161. The second tubular portion 312 is connected to the waste ink tube 162 and derives dye ink via the waste ink tube 162. In this embodiment, the tubular portion 311 is located on the outer side (upstream in the Y direction) with respect to the apparatus main body as compared to the tubular portion 312, and in a state in which the waste ink container 4 is inserted, located on the inner side (downstream in the Y direction) with respect to the waste ink container 4 as compared to the tubular portion 312.

Here, the pigment ink readily solidifies upon, for example, mixing with the dye ink. In this embodiment, as is apparent from FIGS. 6 to 8, in the waste ink container 4, the absorber 43 is arranged such that a space 431 is formed on the lower side of the tubular portion 311 that derives the pigment ink. For this reason, the pigment ink derived by the tubular portion 311 drops into the space 431 without solidifying near the tubular portion 311 and is then absorbed by the absorber 43. On the other hand, since the dye ink derived by the tubular portion 312 hardly solidifies and can widely be absorbed by the absorber 43, the dye ink is absorbed by the absorber 43 without providing a space like the space 431.

Hence, to prevent solidification of the pigment ink near the tubular portion 311, the absorber 43 is arranged to form the space 431 at the center portion in the waste ink container 4 or surround the space 431 at the center portion along the inner wall of the container main body 41. According to this structure, the waste ink container 4 capable of preventing solidification of pigment ink can be implemented with a relatively simple and small structure.

Also, during insertion/removal of the waste ink container 4, the pigment ink may leak from the tubular portion 311 and/or the dye ink may leak from the tubular portion 312. However, according to the structure in which the tubular portion 311 is located on the outer side of the tubular portion 312, it is possible to prevent the pigment ink from solidifying near the tubular portion 311 because of leakage of the dye ink from the tubular portion 312 during insertion/removal of the waste ink container 4.

Furthermore, when the waste ink container 4 is implemented with the small structure, the waste ink container storage unit 21 that stores the waste ink container 4 can also be formed in a small size. Hence, according to the structure, it is advantageous in preventing useless scattering or leakage of waste ink in the waste ink container storage unit 21.

### (Positioning of Waste Ink Container)

According to the above-described structure, at the time of insertion/removal, the waste ink container 4 engages with the tubular portions 311 and 312 of the waste ink output unit 31 and slides in the notch 49. The width of the narrow/substantially linear portion of the notch 49 (most portion of the notch 421) substantially equals the size of the tubular portions 311 and 312, or these are molded such that this is implemented.

According to this configuration, both the tubular portions 311 and 312 do not substantially come into surface contact with the waste ink container 4 at the time of insertion/removal of the waste ink container 4, and come into point contact or linear contact with it. Hence, sliding friction that occurs at the time of insertion/removal of the waste ink container 4 is suppressed, and insertion/removal of the waste ink container 4 can relatively easily be implemented. Each of the tubular portions 311 and 312 need only be formed in such a shape that does not substantially come into surface contact with the waste ink container 4 and typically has a circular shape (cylindrical tube shape) but may have a polygonal shape (polygonal tube shape). That is, the tubular portions 311 and 312 need only function as a channel portion through which a liquid can pass.

Also, according to this structure, the direction of insertion/removal of the waste ink container 4 is regulated, the position deviation of the waste ink container 4 in the X direction is regulated, and the insertion position of the waste ink container 4 can also be regulated by the terminal end of the notch 421. That is, it can be said that the waste ink output unit 31 has not only a function of outputting waste ink into the waste ink container 4 but also a function of positioning the waste ink container 4, and this configuration can be implemented by a relatively small number of components.

The portion of the notch 49 having a wide/open shape (a part of the notch 421 and the notch 411) accepts the waste ink output unit 31 at the time of insertion of the waste ink container 4, and may discriminately be expressed as an accepting portion.

To the contrary, the narrow/substantially linear portion of the notch 49 (most part of the notch 421) slides against the tubular portions 311 and 312 of the waste ink output unit 31 during insertion/removal of the waste ink container 4, and may discriminately be expressed as a sliding portion.

### SUMMARY

According to this embodiment, the waste ink output unit 31 configured to output waste ink in the printhead 11 into the waste ink container 4 includes the tubular portion 311/312. The tubular portion 311/312 is connected to the tube 161/162 and can derive waste ink from the printhead 11.

The tubular portion 311/312 can engage with the waste ink container 4 such that the waste ink container 4 inserted into the apparatus main body is positioned. In this embodiment, the waste ink container 4 includes, on its upper surface portion, the notch 49 extending in the insertion/removal direction of the waste ink container 4. Thus, the waste ink container 4 can slide against the tubular portion 311/312 at the time of insertion/removal.

According to this configuration, the position deviation of the waste ink container 4 in the X direction is prevented, the position in the Y direction that is the insertion/removal direction can be defined, and the waste ink container 4 can appropriately be positioned. Hence, the waste ink output unit 31 has not only a function of outputting waste ink to the outside of the apparatus main body but also a function of positioning the waste ink container 4, and this configuration can be implemented by a relatively small number of components. Hence, according to this embodiment, the user can relatively easily exchange the waste ink container 4, and the waste ink container 4 can be implemented relatively inexpensively. It can be said that this is advantageous in improving usability of the printing apparatus 1.

Also, the notch 49 (mainly the notch 421) substantially linearly extends, and at the time of insertion/removal of the waste ink container 4, the tubular portion 311/312 does not substantially come into surface contact with the waste ink container 4. Hence, sliding friction that occurs at the time of insertion/removal of the waste ink container 4 is suppressed, and insertion/removal of the waste ink container 4 can relatively easily be implemented. It can be said that this is advantageous in further improving usability of the printing apparatus 1.

Furthermore, the waste ink output unit 31 further includes the plate-shaped portion 313 extending from the notch 49 at least partially wide around the lower portion of the tubular portion 311/312. When inserting/removing the waste ink container 4, the plate-shaped portion 313 can engage with the container lid portion 42 of the waste ink container 4, and this can prevent the waste ink container 4 from erroneously falling halfway through the insertion/removal. It can be said that this is advantageous in further improving usability of the printing apparatus 1.

In this embodiment, the two tubular portions 311 and 312 that derive pigment ink and dye ink are provided. The tubular portions 311 and 312 are juxtaposed in the insertion/removal direction of the waste ink container 4, and each can engage with the waste ink container 4 to position the waste ink container 4 inserted into the apparatus main body.

Also, the tubular portion 311 that derives pigment ink is located on the outer side with respect to the apparatus main body as compared to the tubular portion 312 that derives dye ink, and in a state in which the waste ink container 4 is inserted, located on the inner side in the insertion/removal direction of the waste ink container 4 with respect to the waste ink container 4 as compared to the tubular portion 312. Thus, it is possible to prevent, by a relatively simple and small structure, the pigment ink that readily solidifies from being mixed with the dye ink near the inlet of the waste ink container 4 during insertion/removal of the waste ink container 4.

### Modification

In this embodiment, a case where two types of inks including pigment ink and dye ink are used has been described. As another embodiment, one type of ink may be used, and in that case, the tubular portion 311 or 312 is omitted.

As still another embodiment, three or more types of inks may be used. That is, the tubular portions need only be provided as many as the number of ink types. If there are two or more (multiple) tubular portions, these are juxtaposed in one direction such that these can slide against the notch 49.

As yet another embodiment, if three or more tubular portions are used, tubular portions except arbitrary two tubular portions may be formed in a size smaller than the two tubular portions. That is, it is only necessary that at least two tubular portions can slide against the notch 49, and the size of the remaining tubular portions may be smaller than the size of the at least two tubular portions. According to this configuration, sliding of the waste ink container 4 in the Y direction can appropriately be implemented. In addition, even if the number of tubular portions is relatively large, an increase in the above-described sliding friction can be suppressed.

### Second Embodiment

As described above, at the time of insertion/removal of the waste ink container 4, pigment ink may leak from a tubular portion 311 and/or dye ink may leak from a tubular portion 312. Such leaked waste ink may flow on the surface of the side surface portion of a waste ink container 4 during insertion/removal and cause an accidental electrical short circuit or the like and impedes implementation of appropriate electrical connection between a printing apparatus 1 and the waste ink container 4.

In the second embodiment below, a mode capable of implementing appropriate electrical connection for the waste ink container 4 positioned by the above-described first embodiment will be exemplified.

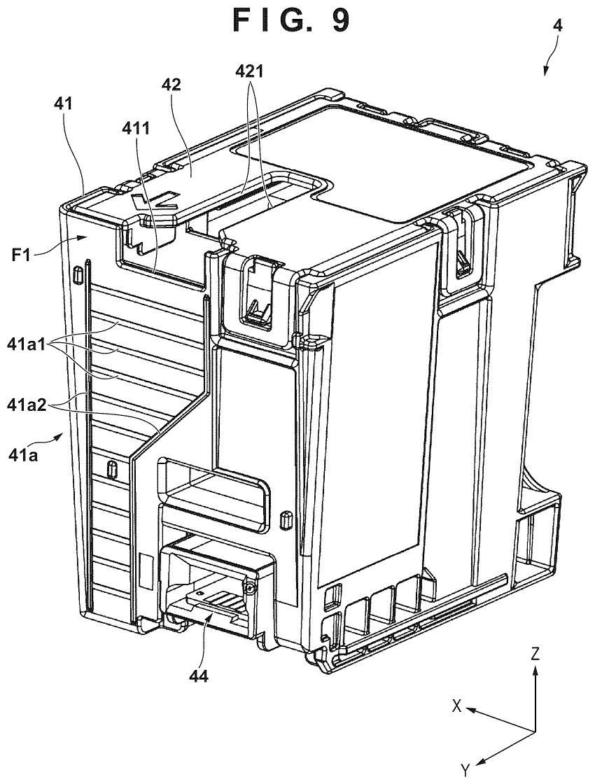

FIG. 9 is a perspective view showing an example of the configuration of the waste ink container 4. The waste ink container 4 includes, on a side surface portion F1 on the apparatus main body side/insertion side, an electrical connecting portion 44 that can electrically be connected to the apparatus main body. When the waste ink container 4 is inserted into the apparatus main body, the electrical connecting portion 44 is electrically connected to an electrical connecting portion 23 of a waste ink container storage unit 21 and enables exchange of signals between the printing apparatus 1 and the waste ink container 4.

The waste ink leaked from the waste ink output unit 31 may flow on the surface of the side surface portion F1 and enter the electrical connecting portion 44. In this embodiment, a guide portion 41a extending in the up/down direction on the upper portion of the electrical connecting portion 44 is formed on the side surface portion F1 of the waste ink container 4. The guide portion 41a has, for example, a concave-convex shape arrayed in a predetermined direction, and in this embodiment, includes a plurality of first convex portions 41al and one or more second convex portions 41a2.

The plurality of convex portions 41al are repetitively formed in the up/down direction and extend in the left/right direction. According to the convex portions 41a1, it is possible to prevent the leaked waste ink from flowing on the surface of the side surface portion F1 toward the electrical connecting portion 44.

The convex portions 41a2 extend at least in the up/down direction to define the edge portions (end portions) of the plurality of convex portions 41al in the left/right direction and, in this embodiment, a pair of left and right convex portions 41a2 are provided. In this case, the convex portions 41a2 are formed higher than each of the plurality of convex portions 41al, and thus, the leaked waste ink flowing on the surface of the side surface portion F1 hardly flows to the outside of the convex portions 41a2. Also, the convex portions 41a2 extend partially in an oblique direction on the upper portion of the electrical connecting portion 44 and guide the leaked waste ink flowing on the surface of the side surface portion F1 in a direction apart from the electrical connecting portion 44.

According to this embodiment, by the above-described configuration, the guide portion 41a prevents the waste ink leaked from the waste ink output unit 31 from reaching the electrical connecting portion 44. It can be said that this can appropriately implement electrical connection between the printing apparatus 1 and the waste ink container 4 and is advantageous in further improving usability of the printing apparatus 1.

As another mode that implements the same function, one or more slits formed in a predetermined direction may alternatively be provided. That is, the one or more slits are formed to prevent the leaked waste ink from flowing on the surface of the side surface portion F1 toward the electrical connecting portion 44 and/or guide the leaked waste ink flowing on the surface of the side surface portion F1 in a direction apart from the electrical connecting portion 44.

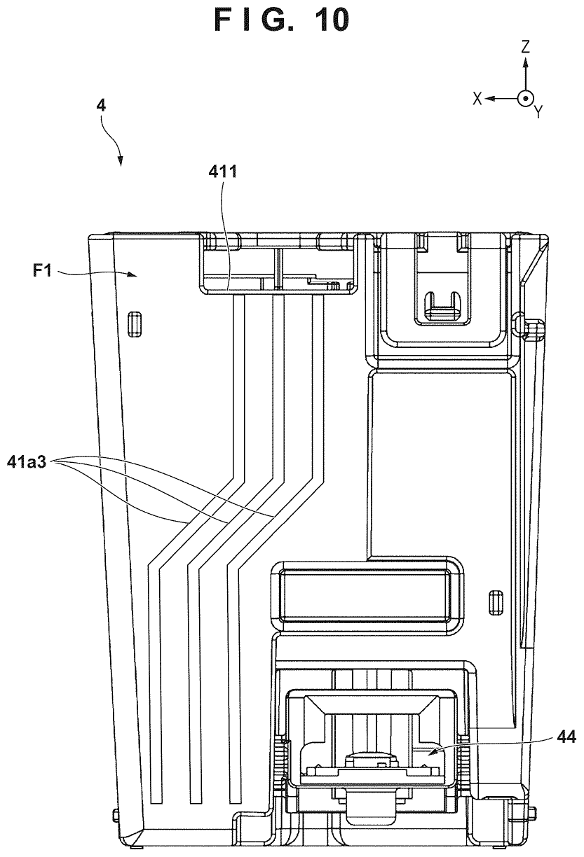

FIG. 10 is a front view showing another example of the configuration of the waste ink container 4. In this example, one or more concave portions 41a3 extending in the up/down direction are provided in place of the convex portions 41al and 41a2. Each concave portion 41a3 extends downward from a notch 411 and extends partially in an oblique direction on the upper portion of the electrical connecting portion 44 and then further extends downward. According to this structure, the leaked waste ink flowing on the surface of the side surface portion F1 can be guided in a direction apart from the electrical connecting portion 44.

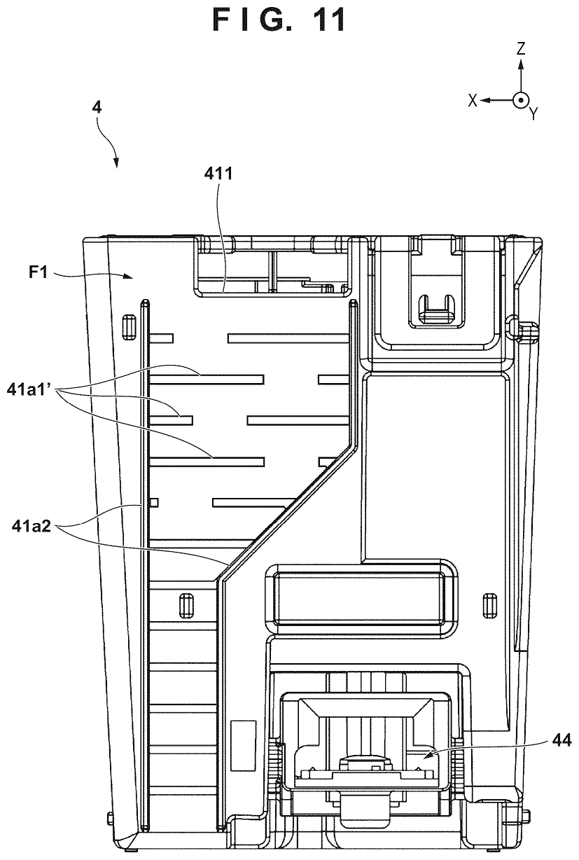

FIG. 11 is a front view showing still another example of the configuration of the waste ink container 4. In this example, maze-like portions 41al′ formed by making some of the plurality of convex portions 41al flat and deforming these into a maze shape are provided such that the leaked waste ink flows on the surface of the side surface portion F1 while meandering to left and right. According to this shape, it is possible to make it difficult for the leaked waste ink to flow on the surface of the side surface portion F1.

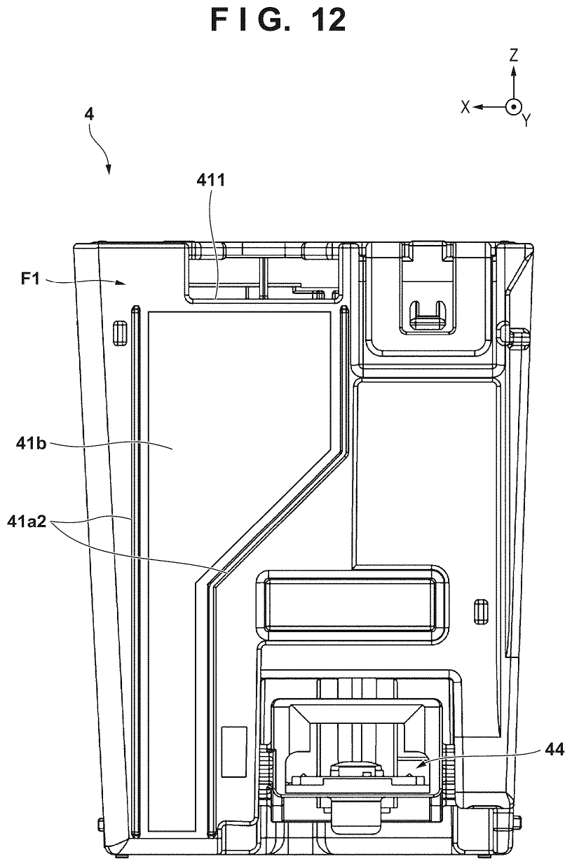

As exemplified in FIG. 12, an absorption member 41b may be arranged at least partially replacing the guide portion 41a. The absorption member 41b is made of a material capable of absorbing the leaked waste ink, for example, the same material as the absorber 43. The absorption member 41b may be arranged inside the left and right convex portions 41a2.

### <<Others>>

In the above explanation, the printing apparatus 1 using the inkjet printing method has been described as an example. However, the printing method is not limited to the above-described mode. Also, the printing apparatus 1 may be a single-function printer having only a printing function or may be a multi-function printer having a plurality of functions such as a printing function, a FAX function, and a scanner function. Also, for example, the printing apparatus may be a manufacturing apparatus configured to manufacture a color filter, an electronic device, an optical device, a microstructure, or the like by a predetermined printing method.

Also, “print” in this specification should be interpreted in a broader sense. Hence, the mode of “print” is usable regardless of whether a target formed on a print medium is significant information such as a character or graphic pattern and also regardless of whether the information has become obvious to allow human visual perception.

“Print media” should also be interpreted in a broader sense, like “print”. Hence, the concept of “print media” can include not only paper that is usable in general but also any members capable of accepting ink, including fabrics, plastic films, metal plates, glass, ceramic, resins, wood, and leather materials.

Furthermore, “ink” should also be interpreted in a broader sense, like “print”. Hence, the concept of “ink” can include not only a liquid that is applied to a print medium to form an image, a design, a pattern, or the like but also an incidental liquid that can be provided to process a print medium or process ink (for example, coagulate or insolubilize color materials in ink applied to a print medium).

In this viewpoint, for example, the printhead 11 may be expressed as a liquid discharge head or simply as a discharge head, and the printing apparatus 1 may be expressed as a liquid discharge apparatus. In the same vein, the waste ink container 4 may be expressed as a waste liquid container or simply as a container. Similarly, the waste ink container storage unit 21 may be expressed as a waste liquid container storage unit or simply as a storage unit, and the waste ink output unit 31 may be expressed as a waste liquid output unit or simply as an output unit.

Also, in the embodiments, each element is named using an expression based on its main function. However, each function described in the embodiments may be a sub-function, and is not strictly limited to the expression. The expression can be replaced with another similar expression. In the same vein, an expression “unit or portion” can be replaced with “tool”, “component”, “member”, “structure”, “assembly”, or the like. Alternatively, these may be omitted or added.

In addition, two or more elements selectably exemplified in the embodiments are not strictly limited to the exemplification, and may arbitrarily be combined. For example, each of the two or more elements exemplified may be additionally selected or alternatively selected. As an example, when arbitrarily combining two elements A and B, to indicate one of “only A”, “only B”, and “both A and B”, an expression “A and/or B” may be used, or an expression “at least one of A and B” may be used.

While the present disclosure has been described with reference to exemplary embodiments, it is to be understood that the present disclosure is not limited to the disclosed exemplary embodiments. The scope of the following claims is to be accorded the broadest interpretation so as to encompass all such modifications and equivalent structures and functions.

What is claimed is:

1. A printing apparatus including a printhead configured to perform printing by discharging ink, the apparatus comprising:
an output unit configured to output waste ink discharged from the printhead; and
a container configured to be inserted/removed into/from an apparatus main body, the container being connected to the output unit and receiving the waste ink output from the output unit in a state in which the container is inserted into the apparatus main body,
wherein the output unit includes a channel portion configured to derive the waste ink,
the channel portion engages with the container to position the container inserted into the apparatus main body, and
the channel portion is configured to not to come into surface contact with the container at the time of insertion/removal of the container.

2. The apparatus according to claim 1, wherein the container includes a notch in an upper surface portion and can slide against the channel portion by the notch at the time of insertion/removal of the container.

3. The apparatus according to claim 2, wherein the notch extends in an insertion/removal direction of the container.

4. The apparatus according to claim 3, wherein the output unit further includes a plate-shaped portion extended wider than the notch in a lower portion of the channel portion.

5. The apparatus according to claim 1, wherein the channel portion is one of not less than two channel portions, and
the not less than two channel portions are juxtaposed in an insertion/removal direction of the container.

6. The apparatus according to claim 5, wherein each of the not less than two channel portions engages with the container to position the container inserted into the apparatus main body.

7. The apparatus according to claim 5, wherein the not less than two channel portions include:
a first channel portion configured to derive pigment ink as the waste ink, and
a second channel portion configured to derive dye ink as the waste ink.

8. The apparatus according to claim 7, wherein the first channel portion is located on an outer side with respect to the apparatus main body as compared to the second channel portion.

9. The apparatus according to claim 8, wherein, in a state in which the container is inserted into the apparatus main body, the first channel portion is located on an inner side in the insertion/removal direction of the container with respect to the container as compared to the second channel portion.

10. The apparatus according to claim 1, wherein the container includes, on a side surface portion, an electrical connecting portion that can electrically be connected to the apparatus main body, and
a guide portion is formed on the side surface portion, the guide portion extending in an up/down direction on an upper portion of the electrical connecting portion and guiding the waste ink such that the waste ink leaked from the output unit is prevented from reaching the electrical connecting portion.

11. The apparatus according to claim 10, wherein the guide portion has a concave-convex shape arrayed in a predetermined direction.

12. The apparatus according to claim 11, wherein the guide portion includes a plurality of first convex portions repetitively formed in the up/down direction and extending in a left/right direction.

13. The apparatus according to claim 12, wherein the guide portion further includes a second convex portion extending at least in the up/down direction to define edge portions of each of the plurality of first convex portions in the left/right direction, and
the second convex portion is formed higher than each of the plurality of first convex portions.

14. The apparatus according to claim 10, wherein the guide portion includes not less than one slit formed in a predetermined direction.

15. The apparatus according to claim 1, wherein the container includes, on a side surface portion, an electrical connecting portion that can electrically be connected to the apparatus main body, and,
on the side surface portion, an absorption member configured to absorb the waste ink leaked from the output unit is arranged on an upper portion of the electrical connecting portion.
